(19) United States
(12) Patent Application Publication
(10) Pub. No.: US 2018/0114129 A1
(43) Pub. Date: Apr. 26, 2018

(54) METHOD AND SYSTEM FOR SYNTHESIS OF AN OPPORTUNITY FOR A COGNITIVE DECISION-MAKING PROCESS

(71) Applicant: Loven Systems, LLC, Northville, MI (US)

(72) Inventors: Satyendra Pal RANA, Northville, MI (US); Chandra Puttanna KEERTHY, Northville, MI (US); Krishna Prakash KALLAKURI, Northville, MI (US)

(21) Appl. No.: 15/788,322

(22) Filed: Oct. 19, 2017

Related U.S. Application Data
(60) Provisional application No. 62/410,737, filed on Oct. 20, 2016.

(51) Int. Cl. G06N 5/04; G06Q 30/02

(52) U.S. Cl. CPC G06N 5/045; G06Q 30/0201

(57) ABSTRACT

The present disclosure relates to system(s) and method(s) to synthesis a business opportunity identified from a set of business opportunities corresponding to an organization for a cognitive decision-making process. In one embodiment, the method comprises receiving an opportunity instance knowledge object associated with a business opportunity identified from a set of business opportunities corresponding to an organization and generation an opportunity instance knowledge specification. The method further comprise generating a first specification based on the opportunity instance knowledge object and generating a second specification based on the opportunity instance knowledge object. The method furthermore comprises appending the first specification and the second specification to the opportunity instance knowledge specification, thereby synthesis a business opportunity identified from a set of business opportunities corresponding to an organization for a cognitive decision-making process the narrative content.

### CROSS REFERENCE TO RELATED APPLICATIONS

This patent application claims priority from U.S. Provisional Application No. 62/410,737 filed on Oct. 20, 2016, the entirety of which is hereby incorporated by reference.

### TECHNICAL FIELD

The present disclosure in general relates to the field of cognitive computing. More particularly, the present subject matter relates to a system and a method to synthesize a business opportunity identified from a set of business opportunities corresponding to an organization for a cognitive decision-making process.

### BACKGROUND

Now a day, to survive and grow in an increasingly complex global economy, organizations strive to find newer and newer methods to improve their performance and competitiveness. Most businesses, large and small, sought to improve business performance by streamlining their processes. The trend has been fueled by digitization, internet of things, and developments in advanced analytics.

Pattern recognition is a branch of machine learning that focuses on the recognition of patterns and regularities in data, although it is in some cases considered nearly synonymous with machine learning. Generally, conventional methods and systems based on known pattern recognition methodologies, for business improvements, fail to understand opportunities in business when implemented in the context of cognitive computing. Further, more, the conventional technologies fail to synthesize a concise documentation comprising various details associated with business opportunity. This is due to high amount of data. In particular, the conventional methods and systems are unable to synthesize opportunity in a cognitive decision-making process in which a high amount of data from internal and external sources is processed.

### SUMMARY

Before the present a system and a method to synthesis a business opportunity identified from a set of business opportunities corresponding to an organization for a cognitive decision-making process, are described, it is to be understood that this application is not limited to the particular systems, and methodologies described, as there can be multiple possible embodiments, which are not expressly illustrated in the present disclosures. It is also to be understood that the terminology used in the description is for the purpose of describing the particular implementations, versions, or embodiments only, and is not intended to limit the scope of the present application. This summary is provided to introduce aspects related to a system and a method to synthesis a business opportunity identified from a set of business opportunities corresponding to an organization for a cognitive decision-making process. This summary is not intended to identify essential features of the claimed subject matter nor is it intended for use in determining or limiting the scope of the claimed subject matter.

In one embodiment, a method to synthesis a business opportunity identified from a set of business opportunities corresponding to an organization for a cognitive decision-making process is disclosed. In the embodiment, the method comprises the step of receiving an opportunity instance knowledge object associated with a business opportunity identified from a set of business opportunities corresponding to an organization. In one example, the opportunity instance knowledge object may comprise one or more symptoms indicative of the business opportunity, a financial amount associated with the business opportunity, a type of the business opportunity, a root cause of the one or more symptoms. Upon receiving, the method may comprise the step of generation of an opportunity instance knowledge specification and generating a first specification based on the opportunity instance knowledge object. In one example, the opportunity instance knowledge specification may be appended to the opportunity instance knowledge object. In one other example, the first specification may comprise one or more of a narrative description corresponding the business opportunity, a visual description corresponding to the business opportunity, an evidence for identifying the business opportunity, and a confidence score associated with the business opportunity. Further to generating, the method may comprise the step of generating a second specification based on the opportunity instance knowledge object. In one more example, the second specification may comprise one or more an impact of inaction, an urgency indicative of the importance of the business opportunity, and an act-by-date. Subsequently, the method may comprise the step of appending the first specification and the second specification to the opportunity instance knowledge specification, thereby synthesis a business opportunity identified from a set of business opportunities corresponding to an organization for a cognitive decision-making process the narrative content.

In another embodiment, a system to synthesize a business opportunity identified from a set of business opportunities corresponding to an organization for a cognitive decision-making process is disclosed. The system comprises a memory and a processor coupled to the memory, further the processor may be configured to execute programmed instructions stored in the memory. In one embodiment, the system may receive an opportunity instance knowledge object associated with a business opportunity identified from a set of business opportunities corresponding to an organization. In an example, the opportunity instance knowledge object may comprise one or more symptoms indicative of the business opportunity, a financial amount associated with the business opportunity, a type of the business opportunity, a root cause of the one or more symptoms. Further, the system may generate an opportunity instance knowledge specification and a first specification based on the opportunity instance knowledge object. In one other example, the opportunity instance knowledge specification may be appended to the opportunity instance knowledge object. In one other example, the first specification may comprise one or more of a narrative description corresponding the business opportunity, a visual description corresponding to the business opportunity, an evidence for identifying the business opportunity, and a confidence score associated with the business opportunity. Furthermore, the system may generate a second specification based on the opportunity instance knowledge object. In one more example, the second specification may comprise one or more an impact of inaction, an urgency indicative of the importance of the business opportunity, and an act-by-date. Finally, the system may append the first specification and the second specification to the opportunity instance knowledge specification, thereby synthesize a business opportunity identified from a set of business opportunities corresponding to an organization for a cognitive decision-making process the narrative content.

In yet another implementation, non-transitory computer readable medium embodying a program executable in a computing device synthesis a business opportunity identified from a set of business opportunities corresponding to an organization for a cognitive decision-making process is disclosed. The program may comprise a program code for receiving an opportunity instance knowledge object associated with a business opportunity identified from a set of business opportunities corresponding to an organization. The program may comprise a program code for generation an opportunity instance knowledge specification. The program may comprise a program code for generating a first specification based on the opportunity instance knowledge object. The program may comprise a program code for generating a second specification based on the opportunity instance knowledge object. The program may comprise a program code for appending the first specification and the second specification to the opportunity instance knowledge specification, thereby synthesis a business opportunity identified from a set of business opportunities corresponding to an organization for a cognitive decision-making process the narrative content.

### BRIEF DESCRIPTION OF THE DRAWINGS

The foregoing detailed description of embodiments is better understood when read in conjunction with the appended drawings. For the purpose of illustrating of the present subject matter, an example of construction of the present subject matter is provided as figures. However, the present subject matter is not limited to the specific a system and a method to synthesis a business opportunity identified from a set of business opportunities corresponding to an organization for a cognitive decision-making process, disclosed in the document and the figures.

The present subject matter is described detail with reference to the accompanying figures. In the figures, the left-most digit(s) of a reference number identifies the figure in which the reference number first appears. The same numbers are used throughout the drawings to refer various features of the present subject matter.

FIG. 1 illustrates an embodiment of a network implementation of a system to synthesis a business opportunity identified from a set of business opportunities corresponding to an organization for a cognitive decision-making process, in accordance with an embodiment of the present subject matter.

FIG. 2 illustrates the system to synthesize a business opportunity identified from a set of business opportunities corresponding to an organization for a cognitive decision-making process, in accordance with an embodiment of the present subject matter.

FIG. 3 illustrates a message flow of the system to synthesize a business opportunity identified from a set of business opportunities corresponding to an organization for a cognitive decision-making process, in accordance with an embodiment of the present subject matter.

FIG. 4 illustrates a method to synthesize a business opportunity identified from a set of business opportunities corresponding to an organization for a cognitive decision-making process, in accordance with an embodiment of the present subject matter.

The figures depicts an embodiment of the present disclosure for purposes of illustration only. One skilled in the art will readily recognize from the following discussion that alternative embodiments of the system and methods to synthesize a business opportunity identified from a set of business opportunities corresponding to an organization for a cognitive decision-making process illustrated herein may be employed without departing from the principles of the disclosure described herein.

### DETAILED DESCRIPTION

Some embodiments of this disclosure, illustrating all its features, will now be discussed in detail. The words “comprising,” “having,” “containing,” and “including,” and other forms thereof, are intended to be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any a system and a method to synthesis a business opportunity identified from a set of business opportunities corresponding to an organization for a cognitive decision-making process, similar or equivalent to those described herein can be used in the practice or testing of embodiments of the present disclosure, the exemplary, a system and a method to synthesis a business opportunity identified from a set of business opportunities corresponding to an organization for a cognitive decision-making process are now described.

Various modifications to the embodiment will be readily apparent to those skilled in the art and the generic principles herein may be applied to other embodiments to synthesis a business opportunity identified from a set of business opportunities corresponding to an organization for a cognitive decision-making process. However, one of ordinary skill in the art will readily recognize that the present disclosure to synthesis a business opportunity identified from a set of business opportunities corresponding to an organization for a cognitive decision-making process is not intended to be limited to the embodiments described, but is to be accorded the widest scope consistent with the principles and features described herein.

In the present disclosure, a business opportunity may be understood as a transient circumstance that comes along the way of a business operation and which needs to be handled strategically in order to promote the business. In other words, the business opportunity may be understood as an opportunity for an organization to gain a profit, reduce a loss, or maintain its hold in the market. Though organization identify these business opportunities, however identifying these business opportunities in real time or even predicting the business opportunities is the key to success. It may be noted that the opportunity synthesis system may identify a business opportunity for which a strategy may be implemented. However, the strategy needs to be implemented on time by a decision maker so as to achieve the designated goal. Therefore, it becomes further important to provide a rationale, an impact and act by date along with the description of the business opportunity for the generating a strategy in a cognitive decision-making process.

In one embodiment, to achieve the above and other advantages, the system and a method to synthesis a business opportunity identified from a set of business opportunities corresponding to an organization for a cognitive decision-making process is disclosed. In the embodiment, an opportunity instance knowledge object associated with a business opportunity identified from a set of business opportunities corresponding to an organization. Further, to receiving, an opportunity instance knowledge specification associated with the business opportunities, a first specification, and a second specification based on the opportunity instance knowledge object is generated. Further, to generating, opportunity instance knowledge specification is appended with the first specification and the second specification and the opportunity instance knowledge specification is appended to the opportunity instance knowledge object, thereby synthesize a business opportunity identified from a set of business opportunities corresponding to an organization for a cognitive decision-making process the narrative content.

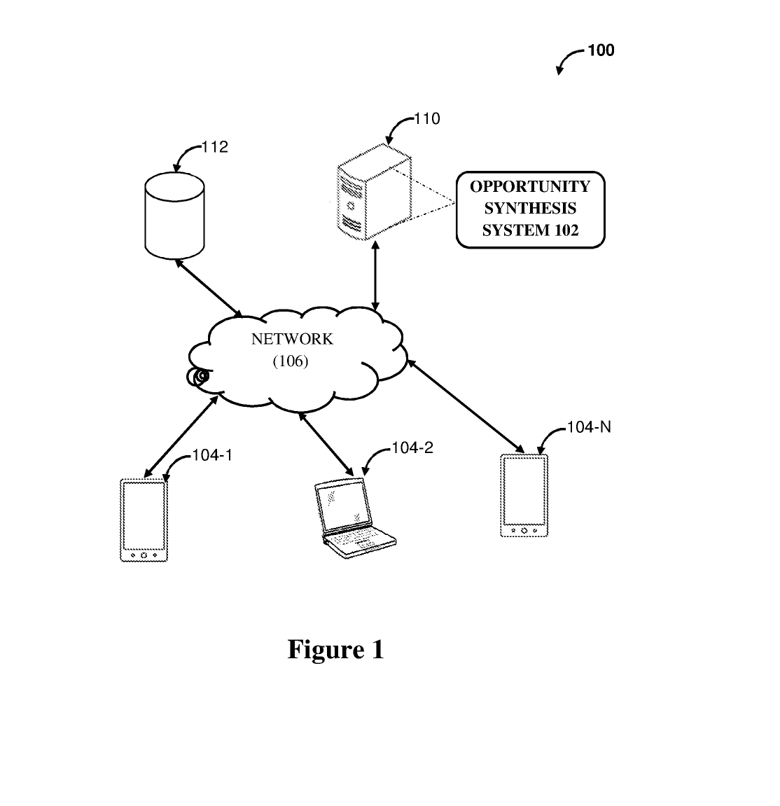

Referring now to FIG. 1, a network implementation 100 of an opportunity synthesis system 102 to synthesize a business opportunity identified from a set of business opportunities corresponding to an organization for a cognitive decision-making process is disclosed. It may be understood that the present disclosure is explained considering that the opportunity synthesis system 102 is implemented on a variety of computing systems, such as a mobile communication device (such as a smartphone), a laptop computer, a desktop computer, a notebook, a workstation, a mainframe computer, a server, a network server, and the like. It will be understood that the opportunity synthesis system 102 may be accessed by multiple users through one or more user devices 104-1, 104-2 . . . 104-N, herein after individually and jointly referred to as user device(s) 104. Examples of the user devices 104 may include, but are not limited to, a portable computer, a personal digital assistant, a handheld device, and a workstation. The user devices 104 are communicatively coupled to the opportunity synthesis system 102 through a network 106. Further, the opportunity synthesis system 102 may be communicatively coupled to knowledge database 112 through the network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

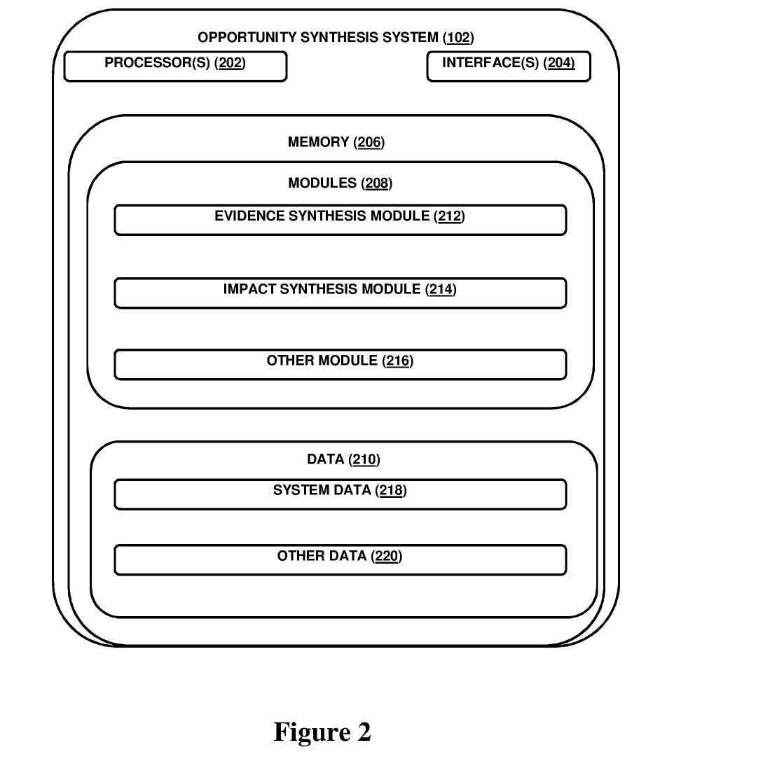

Referring now to FIG. 2, the opportunity synthesis system 102 to synthesize a business opportunity identified from a set of business opportunities corresponding to an organization for a cognitive decision-making process is illustrated in accordance with an embodiment of the present subject matter. In one embodiment, the opportunity synthesis system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the opportunity synthesis system 102 to interact with the user directly or through the client devices 104. Further, the I/O interface 204 may enable the opportunity synthesis system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include an evidence synthesis module 212, an impact synthesis module 214 and other modules 216. The other modules 216 may include programs or coded instructions that supplement applications and functions of the opportunity synthesis system 102. The modules 208 described herein may be implemented as software modules that may be executed in the cloud-based computing environment of the opportunity synthesis system 102.

The data 210, amongst other things, serves as a repository for storing data processed, received, and generated by one or more of the modules 208. Further, the data may include system data 218, and other data 220. The other data 220 may include data generated as a result of the execution of one or more modules in the other modules 216.

In one implementation, the opportunity synthesis system 102 addresses the challenges observed in the existing art. More specifically, the opportunity synthesis system 102 facilitates synthesis of the business opportunity (hereinafter also referred to as opportunity) from a numbers and machine-readable format to human readable description with reasoning for identifying the business opportunity and its impact to the organization. Further, the opportunity synthesis system 102 synthesizes a business opportunity identified from a set of business opportunities corresponding to an organization for a cognitive decision-making process. Example of business opportunity identified may be “Preventing Churn of Customers Opportunity” “Excess Stock Prevention Opportunity”. In one aspect, the excess stock has a cost associated with it and thus, preventing it will cause a net saving. In other aspect, preventing churn of customer has a loss of revenue over the life span of the customer associated with it. Thus upon identifying the business opportunity, the business opportunity has to be explained to the user along with its impact and confidence so that a user may take further action.

In one embodiment, the evidence synthesis module 212 may receive an opportunity instance knowledge object associated with a business opportunity identified from a set of business opportunities corresponding to an organization. In one example, the opportunity instance knowledge object may comprise one or more symptoms indicative of the business opportunity, a financial amount associated with the business opportunity, a type of the business opportunity, a root cause of the one or more symptoms. In the example of “Preventing Churn of Customers Opportunity”, the symptoms may be customers who have not bought from last week; the customers who have reduce the frequency of buying and the like. The root cause may be the customers are out of town, or the customers are buying at the competitors shop and the like. The financial amount may be the customer's historical spending pattern, buying power of the customer and the like. Further, the evidence synthesis module 212 may store the opportunity instance knowledge object in the system data 218.

Upon receiving, the evidence synthesis module 212 may generation an opportunity instance knowledge specification and appended the opportunity instance knowledge specification to the opportunity instance knowledge object. Further, the evidence synthesis module 212 may store the opportunity instance knowledge specification in the system data 218.

Further to generating the opportunity instance knowledge specification, the evidence synthesis module 212 may generate a first specification based on the opportunity instance knowledge object. In one example, the first specification may comprise one or more of a narrative description corresponding the business opportunity, a visual description corresponding to the business opportunity, an evidence for identifying the business opportunity, and a confidence score. In one example, the visual description may comprise of one or more of a photo, an image, a graph, and a video. In another example, the confidence score may be a percentage or a score for indicating the confidence in the business opportunity i.e. the business opportunity is actionable and the symptoms or reasons for the business opportunity are accurate. In one other example, the narrative description corresponding the business opportunity may be generated using a natural language generation methodology (NLG). In one embodiment, the NLG technique may generate the narrative description, in natural language, by performing one or more steps including ‘Content determination’, ‘Document structuring’, ‘Aggregation’, ‘Choice of words’, and ‘Realization’.
Content determination may help in deciding what information needs to be mentioned in the narrative description.
Document structuring: Overall organization of the information to be conveyed.
Aggregation: Merging of similar sentences to improve readability and naturalness.
Choice of words: Choosing appropriate words in accordance with the concept.
Realization: Creating the actual text, that should be formed according to the rules of syntax, morphology, and orthography.

Further, the evidence synthesis module 212 may store the first specification in the system data 218.

Subsequent to generation of first specification, the impact synthesis module 214 may generate a second specification based on the opportunity instance knowledge object. In one example, the second specification comprises one or more of an impact of inaction, an urgency indicative of the importance of the business opportunity, and an act-by-date associated with the business opportunity. In one example, the impact of inaction may be one of a loss in profit, or a loss in brand value, and the urgency is one of a high, medium or low. In one example, the impact of inaction may be determined based on a set of Key Performance Indicators (KPIs) associated to the business opportunity. Further, the set of KPIs may comprise business policy, brand and profit. Furthermore, the impact synthesis module 214 may store the second specification in the system data 218. In one embodiment, the impact synthesis module 214 may generate an impact due to inaction for one or more time period post synthesis a business opportunity, for example impact due to inaction every day or every week after post synthesis a business opportunity

Upon generating the second specification, the impact synthesis module 214 may append the first specification and the second specification to the opportunity instance knowledge specification, thereby synthesis a business opportunity identified from a set of business opportunities corresponding to an organization for a cognitive decision-making process the narrative content. Further, the impact synthesis module 214 may store appended opportunity instance knowledge specification in the system data 218. Further, the impact synthesis module 214 display the first specification and the second specification to a user for strategy to be implemented for the business opportunity.

In addition to the explanation synthesis module 402, the strategy synthesis module 214 further comprises the outcome synthesis module 404. In one aspect, the outcome synthesis module 404 generates an outcome metrics indicating a profit attained when the optimal strategy is implemented.

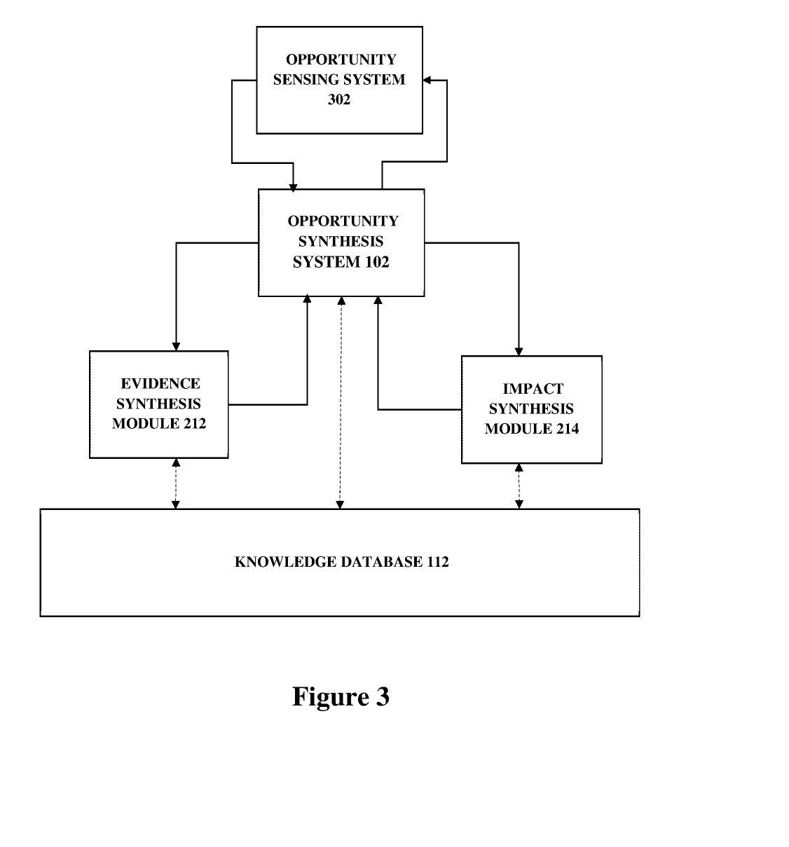

Further, FIG. 3 illustrates the message flow in an opportunity synthesis system 102. The succeeding detailed description of one embodiment of the system 102 along with other components is further explained by referring to FIG. 3.

In one implementation, the opportunity synthesis system 102 is responsible for assembling detailed information about the sensed opportunity. When opportunity synthesis system 102 receives an Opportunity Synthesis Start (O-S-Start) message from and external Opportunity Sensing system 302, the opportunity synthesis system 102 performs synthesis activity resulting in a new Opportunity Instance Knowledge Object (OX-KO) comprising Opportunity Instance Knowledge specification. In one example, the Opportunity Instance Knowledge Object (OX-KO) comprising Opportunity Instance Knowledge specification may be populated with the following information:
Narrative description of the Opportunity in natural language (O-Narrative)
Visual description of the Opportunity in an interactive graphics (or video) (O-Visual)
As an evidence, the reasoning behind how the opportunity was predicted (O-Evidence)
Metrics quantifying the impact, if the opportunity is not addressed in time (O-Impact)
Measure of Confidence in the Opportunity (likelihood of Opportunity actually manifesting) (O-D-Confidence)
Measure of relative importance/urgency for addressing this opportunity (O-Urgency)
Last date to Act (O-Act-By)

In the implementation, the above listed information is available in opportunity instance knowledge specification in two components—Evidence Synthesis Specification (second specification) and Impact Synthesis Specification (first specification). Evidence Synthesis Specification contains knowledge needed to derive O-Narrative, O-Visual, O-Evidence, O-D-Confidence, whereas the Impact Synthesis Specification contains knowledge needed to derive O-Impact, O-Urgency, and O-Act-By, herein in through the description “O represents Opportunity”. In this description, organizing Opportunity Type Specification into individual component specification is for illustrative purposes only. It may be understood that a different flat or hierarchical organization can be used to achieve the same purpose. When an Opportunity Type Knowledge Object (OT-KO) is instantiated by reading from knowledge base in the external Opportunity Sensing system 302, all the component specifications can be instantiated at the same time or later in other modules when needed for the first time.

Further, in one implementation, opportunity synthesis system 102 synthesizes the Opportunity Instance Knowledge Object (OI-KO) comprising opportunity instance knowledge specification by invoking two other modules—Evidence Synthesis Module 212 and Impact Synthesis Module 214. In the example, opportunity synthesis system 102 instantiates Evidence Synthesis module 212 and Impact Synthesis modules 214 as needed or may activate a pool of Evidence Synthesis Modules 212 and Impact Synthesis modules 214 for each opportunity type, during its initialization phase. In one example, the Table 1 below shows top-level message types used by opportunity synthesis system 102.

TABLE 1
Opportunity Synthesis Module - Top Level Message Types
Message Types used by Opportunity Synthesis System 102

| | | Producer | Consumer | |
|---|---|---|---|---|
| # | Message Type | Module | Module | Description |
| 1 | O-S-Start | Opportunity | Opportunity | This message |
| | (Opportunity | Sensing | Synthesis | triggers opportunity |
| | Synthesis | Module | System 102 | synthesis pipeline |
| | Start) | | | |
| 2 | E-S-Start | Opportunity | Evidence | This message |
| | (Evidence | Synthesis | Synthesis | triggers evidence |
| | Synthesis | System 102 | Module 212 | synthesis for the |
| | Start) | | | newly created |
| | | | | opportunity instance |
| 3 | E-S-Done | Evidence | Opportunity | This message is |
| | (Evidence | Synthesis | Synthesis | emitted after |
| | Synthesis | Module 212 | System 102 | completion of |
| | Done) | | | evidence synthesis. |
| 4 | I-S-Start | Opportunity | Impact | This message |
| | (Impact | Synthesis | Synthesis | triggers evidence |
| | Synthesis | System 102 | Module 214 | synthesis for the |
| | Start) | | | newly created |
| | | | | opportunity instance. |
| 5 | I-S-Done | Impact | Opportunity | This message is |
| | (Impact | Synthesis | Synthesis | emitted after |
| | Synthesis | Module 214 | System 102 | completion of |
| | Done) | | | impact synthesis. |
| 6 | O-S-Done | Opportunity | Opportunity | This message is |
| | (Opportunity | Synthesis | Sensing | emitted after |
| | Synthesis | System 102 | Module | receiving after both |
| | Done) | | | E-S-Done and I-S- |
| | | | | Done message for |
| | | | | the newly created |
| | | | | opportunity instance. |

In the implementation, opportunity synthesis system 102 function in multiple phases such as initiation phase, execution phase termination phase. In one example, below description explains an overview of the behavior of the system 102 through various phases.

In one example of the initialization phase, upon start opportunity synthesis system 102 performs the following initialization activities:

/*Set up connections to external message queues*/
1. Using Messaging service, register as consumer to O-S-Start messages queue, created by Opportunity Sensing Module (104).
2. Using Messaging service, register as producer to O-S-Done messages queue created by Opportunity Sensing Module (104).

/*Set up message queues for communication with instances of internal components 212 and 214*/. In one example, if there are 4 opportunity types in OTS-KO, there will be 20 message queues created, 4 for each opportunity type)
3. For entries in Opportunity Types Knowledge Object (OTS-KO):
   a) Get the next entry (Opportunity Type Knowledge Object), say OT-KO
   b) Using messaging service, create E-S-Start, E-S-Done, I-S-Start, and I-S-Done message queues for opportunity type OT-KO.
   c) Register as producer to E-S-Start and I-S-Start message queues.
   d) Register as consumer to E-S-Done and I-S-Done message queues.

/*Start instances of internal components 212 and 214*/. In one example, if there are 4 opportunity types in OTS-KO, there will be 4 instances of each Evidence Synthesis Module 212 and Impact Synthesis Module 214, one for each opportunity type)
4. For entries in Opportunity Types Knowledge Object (OTS-KO):
   a) Get the next entry (Opportunity Type Knowledge Object), say OT-KO
   b) Start an instance of Evidence Synthesis Module passing it the reference to OT-KO
   c) Start an instance of Impact Synthesis Module passing it the reference to OT-KO

In one example in the execution phase, after completing initialization activities, Opportunity Synthesis System 102 executes the following concurrent activities.

/*Listen to Opportunity Synthesis Start (O-S-Start) messages from Opportunity Sensor Module*/
5. Upon receiving the next O-S-Start message, execute the following steps
   a) Get the reference to Opportunity Type Knowledge Object (OT-KO) from the O-S-Start message.
   b) Create a new Opportunity Instance Knowledge Object (OX-KO) of Opportunity Type using the specification in Opportunity Type Knowledge Object in step a. Insert a reference to Opportunity Detection Knowledge Object (OD-KO) available from the O-S-Start message.
   c) Create a new Evidence Synthesis Start (E-S-Start) message and insert a reference to Opportunity Instance Knowledge Object (OX-KO) created in step b. Append the E-S-Start message to the E-S-Start message queue for the Opportunity Type in question.
   d) Create a new Impact Synthesis Start (I-S-Start) message and insert a reference to Opportunity Instance Knowledge Object (OX-KO) created in step b. Append the I-S-Start message to the E-S-Start message queue for the Opportunity Type in question.

/*Listen to normal messages from component modules 212 and 214*/
6. Upon receiving an E-S-Done from an Evidence Synthesis Module 212, execute the following steps:
   a) Get reference to the Opportunity Instance Knowledge Object (OX-KO) from the E-S-Done message.
   a) If impact synthesis has already been inserted into OX-KO, then create a new O-S-Done message; insert reference to OX-KO in this message, and append it to the O-S-Done message queue.
7. Upon receiving an I-S-Done message from an Impact Synthesis Module 214, execute the following steps:
   a) Get reference to the Opportunity Instance Knowledge Object (OX-KO) from the I-S-Done message.
   b) If evidence synthesis has already been inserted into OX-KO, then create a new O-S-Done message; insert reference to OX-KO in this message, and append it to the O-S-Done message queue.

/*Listen to exception/error messages from 212 and 214*/
8. Upon receiving an exception message from Evidence Synthesis Module 212 or Impact Synthesis Module 214, perform the following:
   a) If exception can be handled at opportunity synthesis system 102 level, invoke exception-handling mechanism of the opportunity synthesis system 102. This may involve stopping and restarting component modules 212 and/or 214; otherwise forward an exception message to opportunity sensing module. Save error and recovery logs using logging service.

/*Listen to administrative requests*/
9. Administrative user can interact with Opportunity Synthesis system 102 to:
   a) View the status of opportunity synthesis progress
   b) View errors and logs
   c) Stop and restart Evidence Synthesis Modules 212
   d) Stop and restart Impact Synthesis Modules 214

In one example in the termination phase continues to be active after initialization until, the system itself halts or there is some fault in the system that brings it down. In the latter case, the systems fault-recovery mechanism kicks in to restart opportunity synthesis system 102.

### Evidence Synthesis Module 212

Opportunity synthesis system 102 maintains a pool of Evidence Synthesis Module 212 instances, at least one for each Opportunity Type (analogues to business opportunity) An Evidence Synthesis Module 212 instances works on one opportunity instance at a time. It creates the following objects (first specification) and inserts there references in the received Opportunity Instance Knowledge Object (OX-KO), and for example in the opportunity instance knowledge specification:
O-Narrative
O-Visual
O-Evidence
O-D-Confidence

Several Evidence Synthesis modules are running concurrently in the system. Each such module is associated with an opportunity type. In a simple embodiment, there is one evidence synthesis module 212 for each opportunity type. In alternate embodiments, several evidence synthesis module 212 can be associated with the same opportunity type. In addition, one evidence synthesis module 212 can also be associated with multiple opportunity types. Evidence synthesis module 212 can run on a single machine or it can be a distributed program running on a cluster of machines. All instances of Evidence Synthesis modules 212 can be started in parallel on different machines in a cluster of machines. One or more evidence synthesis module 212 can also be started on a single machine.

An Evidence Synthesis Module 212 accepts E-S-Start (Evidence Synthesis Start) message with a reference to Opportunity Instance Knowledge Object and after completion of its execution, it emits E-S-Done (Evidence Synthesis Done) message.

In the implementation, evidence synthesis module 212 function in multiple phases such as initiation phase, execution phase termination phase. In one example, below description explains an overview of the behavior of the evidence synthesis module 212. Further, in one example, let OT is the opportunity type associated with this instance (available from the parameter opportunity type knowledge object, OT-KO, passed with the start request.)

/*set up connections to external message queues*/
1. Using Messaging service, register as consumer to E-S-Start messages queue for opportunity type OT, created by Opportunity synthesis system 102.
2. Using Messaging service, register as producer to E-S-Done messages queue for opportunity type OT, created by Opportunity synthesis system 102.

/*configure evidence synthesis code*/
3. From the associated Opportunity Type Knowledge Object, OT-KO, get the following information:
   a) Specification to build O-Narrative
   b) Specification to build O-Visual
   c) Specification to build O-Evidence
   d) Specification to build O-D-Confidence
4. Using the specifications obtained in step 4 configure evidence synthesis code.

In one example in the execution phase, after initialization, evidence synthesis module 212 runs in a loop executing the following steps:

/*Listen to message E-S-Start (Evidence Synthesis Start) from Opportunity Synthesis system 102*/
5. Upon receiving an E-S-Start message, perform the following:
   a) Get reference to Opportunity Instance Knowledge Object (OX-KO)
   b) Build O-Narrative and insert in OX-KO
   c) Build O-Visual and insert in OX-KO
   d) Build O-Evidence and insert in OX-KO
   e) Build O-D-Confidence and insert in OX-KO
   f) Create a new E-S-Done (Evidence Synthesis Done) message
   g) Insert a reference to OX-KO in the message created in step f.
   h) Append the message to E-S-Done messages queue of the opportunity type of OX-KO
6. Using Logging Service, create an evidence synthesis log record.

In the termination phase of the implementation, evidence synthesis modules 212 may be started/restarted at the beginning of each iteration of the detection loop and terminated at the end of the iteration. Alternately, these modules can be kept running waiting for the next iteration after processing opportunity input package for the current iteration. If an evidence synthesis module halts because of failure, the systems fault-recovery mechanism kicks in to restart the evidence synthesis module 212.

### Impact Synthesis Module 214

In the said implementation, opportunity synthesis system 102 maintains a pool of Impact Synthesis Module 214 instances, at least one for each Opportunity Type. An Impact Synthesis Module 214 instances works on one opportunity instance at a time. It creates the following objects (second specification) and inserts there references in the received Opportunity Instance Knowledge Object (OX-KO) and for example in the opportunity instance knowledge specification:
O-Impact
O-Urgency
O-Act-By

Several Impact Synthesis modules 214 maybe running concurrently in the system. Each such module is associated with an opportunity type. In one example, business opportunity may be understood as the types of business opportunity such as loss prevention, profit creation, brand protection and the like. In a simple embodiment, there is one impact synthesis module 214 for each opportunity type. In alternate embodiments, several impact synthesis modules can be associated with the same opportunity type. In addition, one impact synthesis modules 214 can also be associated with multiple opportunity types. Impact synthesis modules 214 can run on a single machine or it can be a distributed program running on a cluster of machines. All instances of impact synthesis modules 214 can be started in parallel on different machines in a cluster of machines. One or more impact synthesis Modules 214 can also be started on a single machine.

An Impact Synthesis Module 214 accepts I-S-Start (Impact Synthesis Start) message with a reference to Opportunity Instance Knowledge Object and after completion of its execution, it emits I-S-Done (Impact Synthesis Done) message.

In the implementation, impact synthesis module 214 functions in multiple phases such as initiation phase, execution phase termination phase. In one example, below description explains an overview of the behavior of the impact synthesis module 214. In one example in the initialization phase, upon start the impact synthesis module 214 performs the following initialization activities. In one example, let OT is the opportunity type associated with this instance (available from the parameter opportunity type knowledge object, OT-KO, passed with the start request.)

/*set up connections to external message queues*/
1. Using Messaging service, register as consumer to I-S-Start messages queue for opportunity type OT, created by Opportunity synthesis system 102.
2. Using Messaging service, register as producer to I-S-Done messages queue for opportunity type OT, created by Opportunity synthesis system 102.

/*configure impact synthesis code*/
3. From the associated Opportunity Type Knowledge Object, OT-KO, get the following information:
   a) Specification to build O-Impact
   b) Specification to build O-Urgency
   c) Specification to build O-Act-By
4. Using the specifications obtained in step 4, configure impact synthesis code.

In one example in the execution phase, after initialization, impact synthesis module 214 runs in a loop executing the following steps:

/*Listen to message I-S-Start (Impact Synthesis Start) from Opportunity Synthesis system 102*/
5. Upon receiving an I-S-Start message, perform the following:
   a) Get reference to Opportunity Instance Knowledge Object (OX-KO)
   b) Build O-Impact and insert in OX-KO
   c) Build O-Urgency and insert in OX-KO
   d) Build O-Act-By and insert in OX-KO
   e) Create a new I-S-Done (Impact Synthesis Done) message
   f) Insert a reference to OX-KO in the message created in step e.
   g) Append the message to I-S-Done messages queue of the opportunity type of OX-KO
6. Using Logging Service, create an impact synthesis log record.

In one example in the termination phase, the impact synthesis modules 214 may be started/restarted at the beginning of each iteration of the detection loop and terminated at the end of the iteration. Alternately, impact synthesis modules 214 can be kept running waiting for the next iteration after processing opportunity input package (an opportunity instance knowledge object) for the current iteration. If an impact synthesis modules 214 halts because of failure, the systems fault-recovery mechanism kicks in to restart the impact synthesis modules 214.

In one example in the termination phase, an opportunity synthesis system 102 continues to be active after initialization until there is some fault in the system that brings it down. In the latter case, the system fault-recovery mechanism kicks in to restart an opportunity synthesis system 102.

Exemplary embodiments to synthesize a business opportunity identified from a set of business opportunities corresponding to an organization for a cognitive decision-making process discussed above may provide certain advantages. Though not required to practice aspects of the disclosure, these advantages may include those provided by the following features.

Some embodiments of the system and the method enable automated conversion of machine-readable data to human readable data.

Some embodiments of the system and the method enable generation of natural language describing reasons and impact of inaction.

Some embodiments of the system and the method effective generation of a strategy to benefit for the identified business opportunity.

Some embodiments of the system and the method enables real time synthesis of business opportunity.

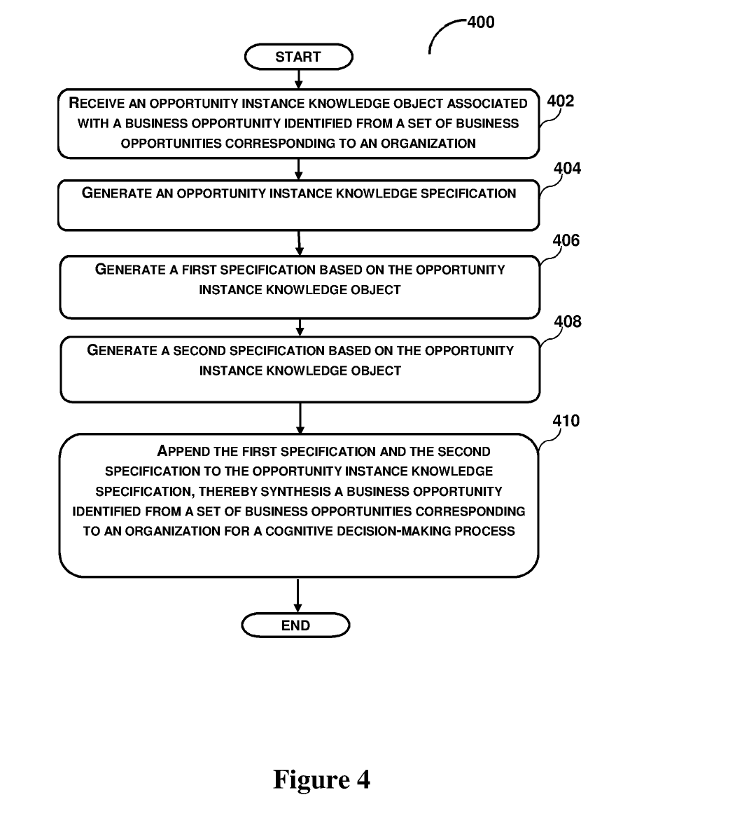

Referring now to FIG. 4, a method 400 to synthesize a business opportunity identified from a set of business opportunities corresponding to an organization for a cognitive decision-making process is disclosed in accordance with an embodiment of the present subject matter. The method 400 to synthesize a business opportunity identified from a set of business opportunities corresponding to an organization for a cognitive decision-making process may be described in the general context of device executable instructions. Generally, device executable instructions can include routines, programs, objects, components, data structures, procedures, modules, functions, and the like, that perform particular functions or implement particular abstract data types. The method 400 to synthesis a business opportunity identified from a set of business opportunities corresponding to an organization for a cognitive decision-making process may also be practiced in a distributed computing environment where functions are performed by remote processing systems that are linked through a communications network. In a distributed computing environment, computer executable instructions may be located in both local and remote computer storage media, including memory storage systems.

The order in which the method 400 to synthesis a business opportunity identified from a set of business opportunities corresponding to an organization for a cognitive decision-making process is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method 400 can be implemented in any suitable hardware, software, firmware, or combination thereof. However, for ease of explanation, in the embodiments described below, the method 400 to synthesize a business opportunity identified from a set of business opportunities corresponding to an organization for a cognitive decision-making process may be considered to be implemented in the above-described system 102.

At block 402, an opportunity instance knowledge object associated with a business opportunity identified from a set of business opportunities corresponding to an organization is received. In one example, the opportunity instance knowledge object may comprise one or more symptoms indicative of the business opportunity, a financial amount associated with the business opportunity, a type of the business opportunity, a root cause of the one or more symptoms. In one embodiment, the evidence synthesis module 212 may receive the opportunity instance knowledge object. Further, the evidence synthesis module 212 may store the opportunity instance knowledge object in the system data 218.

At block 404, an opportunity instance knowledge specification associated with the business opportunity may be generated. In one embodiment, the evidence synthesis module 212 may generate an opportunity instance knowledge specification. Further, the evidence synthesis module 212 may store the opportunity instance knowledge specification in the system data 218.

At block 406, a first specification may be generated based on the opportunity instance knowledge object. In one example, the first specification may comprise one or more of an impact of inaction, an urgency indicative of the importance of the business opportunity, and an act-by-date. In one embodiment, the evidence synthesis module 212 may generate a first specification. Further, the evidence synthesis module 212 may store the first specification in the system data 218.

At block 408, a second specification may be generated based on the opportunity instance knowledge object. In one example, the second specification may comprise a narrative description corresponding the business opportunity, a visual description corresponding to the business opportunity, an evidence for identifying the business opportunity, and a confidence score associated with the business opportunity. In one embodiment, the impact synthesis module 214 may generate a second specification. Further, the impact synthesis module 214 may store the second specification in the system data 218.

At block 410, the first specification and the second specification may be appended to the opportunity instance knowledge specification, thereby synthesize a business opportunity identified from a set of business opportunities corresponding to an organization for a cognitive decision-making process the narrative content. In one embodiment, the impact synthesis module 214 may append the first specification and the second specification to the opportunity instance knowledge specification. Further, the impact synthesis module 214 may store appended opportunity instance knowledge specification in the system data 218.

Although implementations for methods and systems to synthesize a business opportunity identified from a set of business opportunities corresponding to an organization for a cognitive decision-making process have been described in language specific to structural features and/or methods, it is to be understood that the appended claims are not necessarily limited to the specific features or methods to synthesize a business opportunity identified from a set of business opportunities corresponding to an organization for a cognitive decision-making process described. Rather, the specific features and methods are disclosed as examples of implementations to synthesize a business opportunity identified from a set of business opportunities corresponding to an organization for a cognitive decision-making process.

1. A method to synthesize a business opportunity identified from a set of business opportunities corresponding to an organization for a cognitive decision-making process, the method comprising:
receiving, by the processor, an opportunity instance knowledge object associated with a business opportunity identified from a set of business opportunities corresponding to an organization, wherein the opportunity instance knowledge object comprises one or more symptoms indicative of the business opportunity, an financial amount associated with the business opportunity, a type of the business opportunity, a root cause of the one or more symptoms;
generation, by a processor, an opportunity instance knowledge specification, wherein the opportunity instance knowledge specification is appended to the opportunity instance knowledge object;
generating, by a processor, a first specification based on the opportunity instance knowledge object, wherein the first specification comprises one or more of a narrative description corresponding the business opportunity, a visual description corresponding to the business opportunity, an evidence for identifying the business opportunity, and a confidence score as;
generating, by the processor, a second specification based on the opportunity instance knowledge object, wherein the second specification comprises one or more of an impact of inaction, an urgency indicative of the importance of the business opportunity, and an act-by-date associated with the business opportunity; and
appending, by the processor, the first specification and the second specification to the opportunity instance knowledge specification, thereby synthesize a business opportunity identified from a set of business opportunities corresponding to an organization for a cognitive decision-making process the narrative content.

2. The method of claim 1 further comprises displaying, by the processor, the first specification and the second specification strategy to user for to be implemented for the business opportunity.

3. The method of claim 1, wherein the impact of inaction is one of a loss in profit, or a loss in brand value, and wherein the urgency is one of a high, medium or low.

4. The method of claim 1, wherein the visual description comprises of one or more of a photo, an image, a graph, and a video.

5. The method of claim 1, further comprises determining, by the processor, the impact of inaction based on a set of Key Performance Indicators (KPIs) associated to the business opportunity, and wherein the set of KPIs comprises business policy, brand and profit.

6. The method of claim 1, wherein the narrative description corresponding the business opportunity is generated using a natural language generation methodology (NLG).

7. The method of claim 6, wherein the NLG methodology is one of a Content determination methodology, a Document structuring methodology, a Aggregation methodology, a Choice of words methodology, and a Realization methodology.

8. The method of claim 1 further comprises generating, by the processor, an impact due to inaction for one or more time period post synthesis a business opportunity.

9. A opportunity synthesis system to synthesize a business opportunity identified from a set of business opportunities corresponding to an organization for a cognitive decision-making process, the strategy planning system comprising:
a processor; and
a memory coupled to the processor, wherein the processor is capable of executing a plurality of modules stored in the memory, and wherein the plurality of modules comprising:
receiving an opportunity instance knowledge object associated with a business opportunity identified from a set of business opportunities corresponding to an organization, wherein the opportunity instance knowledge object comprises one or more symptoms indicative of the business opportunity, an financial amount associated with the business opportunity, a type of the business opportunity, a root cause of the one or more symptoms;
generation an opportunity instance knowledge specification, wherein the opportunity instance knowledge specification is appended to the opportunity instance knowledge object;
generating a first specification based on the opportunity instance knowledge object, wherein the first specification comprises one or more of a narrative description corresponding the business opportunity, a visual description corresponding to the business opportunity, an evidence for identifying the business opportunity, and a confidence score;
generating a second specification based on the opportunity instance knowledge object, wherein the second specification comprises one or more of an impact of inaction, an urgency indicative of the importance of the business opportunity, and an act-by-date associated with the business opportunity; and
appending the first specification and the second specification to the opportunity instance knowledge specification, thereby synthesis a business opportunity identified from a set of business opportunities corresponding to an organization for a cognitive decision-making process the narrative content.

10. The opportunity synthesis system of claim 9 further comprises displaying the first specification and the second specification to user for strategy to be implemented for the business opportunity.

11. The opportunity synthesis system of claim 9, wherein the impact of inaction is one of a loss in profit, or a loss in brand value, and wherein the urgency is one of a high, medium or low.

12. The opportunity synthesis system of claim 9, wherein the visual description comprises of one or more of a photo, an image, a graph, and a video.

13. The opportunity synthesis system of claim 9, wherein the impact of inaction is further determined based on a set of Key Performance Indicators (KPIs) associated to the business opportunity, and wherein the set of KPIs comprises business policy, brand and profit.

14. The opportunity synthesis system of claim 9, wherein the narrative description corresponding the business opportunity is generated using a natural language generation methodology (NLG).

15. The opportunity synthesis system of claim 14, wherein the NLG methodology is one of a Content determination methodology, a Document structuring methodology, a Aggregation methodology, a Choice of words methodology, and a Realization methodology.

16. The opportunity synthesis system of claim 9, further comprises generating an impact due to inaction for one or more time period post synthesis a business opportunity.

17. A non-transitory computer readable medium embodying a program executable in a computing device to synthesis a business opportunity identified from a set of business opportunities corresponding to an organization for a cognitive decision-making process, the program comprising a program code for:
receiving an opportunity instance knowledge object associated with a business opportunity identified from a set of business opportunities corresponding to an organization, wherein the opportunity instance knowledge object comprises one or more symptoms indicative of the business opportunity, an financial amount associated with the business opportunity, a type of the business opportunity, a root cause of the one or more symptoms;
generation an opportunity instance knowledge specification, wherein the opportunity instance knowledge specification is appended to the opportunity instance knowledge object;
generating a first specification based on the opportunity instance knowledge object, wherein the first specification comprises one or more of a narrative description corresponding the business opportunity, a visual description corresponding to the business opportunity, an evidence for identifying the business opportunity, and a confidence score as;
generating a second specification based on the opportunity instance knowledge object, wherein the second specification comprises one or more of an impact of inaction, an urgency indicative of the importance of the business opportunity, and an act-by-date associated with the business opportunity; and
appending the first specification and the second specification to the opportunity instance knowledge specification, thereby synthesis a business opportunity identified from a set of business opportunities corresponding to an organization for a cognitive decision-making process the narrative content.

18. The non-transitory computer readable medium of claim 17 further comprises
determining the impact of inaction based on a set of Key Performance Indicators (KPIs) associated to the business opportunity, and wherein the set of KPIs comprises business policy, brand and profit;
generating an impact due to inaction for one or more time period post synthesis a business opportunity; and
displaying the first specification and the second specification to user for strategy to be implemented for the business opportunity.

19. The non-transitory computer readable medium of claim 17, wherein the impact of inaction is one of a loss in profit, or a loss in brand value, and wherein the urgency is one of a high, medium or low, wherein the visual description comprises of one or more of a photo, an image, a graph, and a video

20. The non-transitory computer readable medium of claim 17, wherein the narrative description corresponding the business opportunity is generated using a natural language generation (NLG) methodology, and wherein the NLG methodology is one of a Content determination methodology, a Document structuring methodology, a Aggregation methodology, a Choice of words methodology, and a Realization methodology.
